(19) United States
(12) Patent Application Publication
(10) Pub. No.: US 2004/0057494 A1
(43) Pub. Date: Mar. 25, 2004

(54) Ear thermometer with improved temperature coefficient and method of calibration thereof

(76) Inventors: Simon Tsao, Hsin Chu (TW); Nien-Yu Weng, Hsin Chu (TW); Yung-Chang Chang, Hsin Chu (TW); Chien-Chang Liao, Hsin Chu (TW)

Correspondence Address: MARTINE & PENILLA, LLP, 710 LAKEWAY DRIVE, SUITE 170, SUNNYVALE, CA, 94085, US

(21) Appl. No.: 10/251,600

(22) Filed: Sep. 19, 2002

(51) Int. Cl. G01J 5/00

(52) U.S. Cl. 374/121

(57) ABSTRACT

An ear thermometer is tested at the time of manufacturing calibration for determining a temperature coefficient to be stored in information storing means. Based on the temperature coefficient, signal processing means compensates an undesirable temperature deviation caused by a change of an ambient temperature upon temperature taking, thereby enhancing the accuracy of the ear thermometer. Also, a method is provided for calibrating the ear thermometer by determining the temperature coefficient without increasing additional cost and calibration procedures.

### BACKGROUND OF THE INVENTION

1. Field of the Invention

The present invention relates to a thermometer with an improved temperature coefficient and a method of improving the thermometer and, more particularly, to an ear thermometer with an improved temperature coefficient and a method of improving the ear thermometer.

2. Description of the Related Art

Clinical thermometers offer body temperatures that help diagnose illnesses. There are several parts of the human body that can be measured body temperatures, including tympanic membrane, mouth, rectum, and armpit. Among them, a body temperature taken from the tympanic membrane is considered to be more representative than the others because it is measured by detecting the infrared radiation emitted from the tympanic membrane. Besides, as to the time needed for measuring the temperature, a conventional thermometer such as a mercury thermometer takes longer time than the ear thermometer does because the former requires a body contact that takes some time before the thermometer can finish sensing the body temperature. Therefore, using the ear thermometer is more prevalent today than using the others.

With regard to the infrared ear thermometer, at first, the principle of infrared radiation sensing utilized to measure the temperature of a target such as a tympanic membrane will be illustrated below:

An infrared ear thermometer is realized through application of a well-known thermoelectric effect. The infrared ear thermometer is provided with infrared radiation sensor means made of a thermoelectric material. When the heat exchange by radiation begins because a temperature difference occurs between the infrared radiation sensor means and its target, the infrared radiation sensor means is heated by the infrared radiation emitted from the target, making the temperature of the sensor means change. Besides, because of the nature of the thermoelectric material, an unbalanced transient charge will be generated on the sensor means (i.e., the thermoelectric effect). The unbalanced transient charge will then generate an electronic signal through an external circuit. The relationship between the temperature of the sensor means and the electronic signal can be expressed by the Stefan-Boltzmann Theorem:

V_{det}=Kₐ(Tₑₐᵣ⁴−Tₐₘₚ⁴) (A)

or can be expressed as follows:

V_{det}×Kₜ=Tₑₐᵣ⁴−Tₐₘₚ⁴ (B)

where V_{det} is the electronic signal generated by the sensor means, Tₑₐᵣ is the target temperature, Tₐₘₚ is the ambient temperature, Kₐ is a constant, and Kₜ is the reciprocal of Kₐ, which is also a constant. As clearly seen from the above equations (A) or (B), the specific values of the electronic signal V_{det} generated by the infrared radiation sensor means and the ambient temperature Tₐₘₚ must be determined in advance before it is possible for the target temperature Tₑₐᵣ to be measured by the infrared ear thermometer.

Next, the conventional procedures of executing the manufacturing calibration for an ear thermometer will be introduced briefly. The first step is that the temperature sensor means of the ear thermometer, without being assembled with a housing and a thermal shielding, is calibrated at an ambient temperature between 15° C. and 30° C., in order to make sure that the temperature inaccuracy or error can be reduced to a minimum when the temperature sensor means is taking a measurement of the ambient temperature. This first calibration step takes about 30 to 50 seconds so as to allow the ear thermometer to reach a stable temperature in thermal equilibrium. The second step is to calculate the value of Kₜ by substituting a given ambient temperature, a given target temperature, and a given output of the sensor means for corresponding terms in equation (B). Then, the value of Kₜ calculated from equation (B) is recorded and ready for calculating the target temperature upon temperature taking. However, it is for an ear thermometer having been assembled with a housing and a thermal shielding that the second calibration step is performed. Typically, in the second calibration step, it is necessary for the ear thermometer to take about 10 minutes to reach a stable temperature in thermal equilibrium.

In fact, Kₜ is a function of the ambient temperature rather than a constant. Assume Kₜ has a temperature coefficient of 0.00025, for example. In this case, if the ambient temperature is 25° C., then there is little temperature inaccuracy or error for an ear temperature of 41° C. to be measured. However, if the ambient temperature is 10° C., then there is a temperature inaccuracy of 0.1° C. for an ear temperature of 41° C. to be measured. The temperature coefficient can be affected by many different factors, such as the size of an aperture for receiving infrared radiation, the transmittance of a housing of an ear thermometer, the responsive extent of the thermoelectric effect, and an internal voltage reference, since these factors are affected by the ambient temperature.

To sum up, if the temperature coefficient is a fixed value, the Kₜ will also be a fixed value without affection by the ambient temperature. Therefore, an ear thermometer having been subject to the manufacturing calibration will calculate the target temperature according to the value of Kₜ. Conversely, if the temperature coefficient is not a fixed value and each ear thermometer may have a different temperature coefficient, the temperature inaccuracy may occur due to changes of the ambient temperature upon temperature taking. In order to solve the problem of the temperature inaccuracy, when the manufacturing calibration is executed, the value of Kₜ must be calibrated twice at two different ambient temperatures, i.e., 25° C. and lower than 10° C., respectively. However, the conventional solution has a drawback in that the ear thermometer requires at least 30 minutes to reach a stable temperature in thermal equilibrium when the lower-than-10-degree calibration is executed, resulting in significant consumption of time.

A conventional radiation thermometer is disclosed in the U.S. Pat. No. 4,797,840. A calibration circuit of the conventional radiation thermometer and a method of calibrating the same will be described below with reference to FIGS. 1 and 2. As shown in FIG. 1, the calibration circuit 10 utilizes pyroelectric sensor means 11 including a pyroelectric film 15, which is also a piezoelectric film, and an outer planar electrode 12 located at the outer side of the pyroelectric film 15 and composed of two separate electrode segments 13 and 14. The calibration circuit 10 further includes an amplifier circuit 17, a microprocessor 18, a switch 16, and a signal excitation circuit 19. The electrode segment 14 is connected to the amplifier circuit 17 while the electrode segment 13 is connected to the switch 16. Through the switch 16, the electrode segment 13 is connected either to the amplifier circuit 17 or to the signal excitation circuit 19 alternatively. The signal excitation circuit 19 can generate a predetermined electrical calibration signal 20 for exciting the pyroelectric film 15 to generate a responsive electrical signal 21, as shown in FIG. 2. The very value of the responsive electrical signal 21 at the time of manufacturing calibration is saved as a predetermined standard responsive electrical signal. At the time of calibration before temperature taking, the switch 16 and the signal excitation circuit 19 are controlled by the microprocessor 18. The signal excitation circuit 19 may receive instructions from the microprocessor 18 and generates the predetermined electrical calibration signal 20. The reference numeral 22 shown in FIG. 1 indicates a wave guide with a shape of a hollow tube for guiding the infrared radiation emitted from the target into the pyroelectric sensor means 11. The reference numeral 23 indicates a shutter (its driving mechanism is not shown) that permits the infrared radiation passing through to reach the pyroelectric sensor means 11 only during a desirable time period.

Next, a procedure of calibrating a conventional thermoelectric radiation thermometer upon temperature taking will be explained below. Immediately before the temperature measurement begins, with the shutter 23 being closed, the electrode segment 13 is connected to the signal excitation circuit 19 by the switch 16 and the predetermined electrical calibration signal 20 is imposed on the electrode segment 13. Because of the nature of the pyroelectric film 15, a mechanical stress is formed and, in turn, makes the pyroelectric film 15 generate a responsive electrical signal 21′ on the electrode 12. The electrical signal 21′ is transmitted to the amplifier circuit 17 through the electrode segment 14 and then transmitted again to the microprocessor 18 for processing. Because the electrical calibration signal 20 is a predetermined value, the difference between the values of the responsive electrical signal 21′ and the predetermined standard responsive electrical signal 21 provides calibration information necessary for executing an appropriate calibration by the microprocessor 18.

After the calibration, a process of temperature measurement is ready to perform. First, the electrode segment 13 is connected to the amplifier circuit 17 by the switch 16 and the shutter 23 is open for guiding the infrared radiation generated by the target 1 into the pyroelectric sensor means 11 through the wave guide 22. The pyroelectric sensor means 11 is optically heated by the infrared radiation and then generates a value of the responsive power Vₜ′. Next, the microprocessor 18 executes the calibration according to the calibration information obtained from the above-mentioned calibrating process so that the undesirable temperature deviation can be compensated. Therefore, a corrected responsive power Vₜ is obtained. The temperature of the target 1 is calculated by the following equation (C):

Vₜ=f(Tₐ)×(Tₜ⁴−Tₐ⁴) (C)

where Tₐ is the ambient temperature, Tₜ is the target temperature, Vₜ is the value of the responsive power after calibration, and f(Tₐ) is a function of the ambient temperature Tₐ, which is further expressed by the following equation (D):

F(Tₐ)=a₀+a₁×Tₐ²+a₂×Tₐ²+a₃×Ta³+ (D)

where the coefficients a₀, a₁, a₂, a₃, . . . is determined by the sensor means. The serial coefficients can be calculated by substituting the given target temperature, the ambient temperature, and the value of the responsive power in the equation (D). In order to achieve a satisfactory degree of accuracy for the human body temperature measurement, it is necessary at the time of manufacturing calibration to take at least three sets of measurements for given target temperatures and ambient temperatures thereby obtaining the coefficients a₀, a₁, and a₂. If a higher accuracy is required, the number of the sets of the given target temperatures and the ambient temperatures must be more than three in order to obtain more than three coefficients. By doing so, the time needed for processing the manufacturing calibration will be increased tremendously.

Another conventional radiation thermometer is disclosed in the U.S. Pat. No. 4,895,164. As shown in FIGS. 3 and 4, the configuration of the thermometer includes a housing 33 with an infrared radiation receiving port 32, infrared radiation sensor means 30 with a wave guide 31 for receiving infrared radiation and infrared radiation detector means 41 for receiving the infrared radiation from the wave guide 31 and generating a first electronic signal, temperature sensor means 42 for measuring the temperature of the infrared radiation detector means 41 and generating a second electronic signal, and signal processing means 34 for processing the first electronic signal and the second electronic signal and outputting an electronic signal that displays the temperature taken from the target. The infrared radiation sensor means 30 further includes a heat conducting block 40, as shown in FIG. 4, for keeping the infrared radiation detector means 41 and the temperature sensor means 42 in an isothermal state. Thus, when the ambient temperature changes, the target temperature, which is affected by temperature drifting, can be corrected according to the second electronic signal detected by the temperature sensor means 42. In addition, the air space 35 provided between the housing 33 and the infrared radiation sensor means 30 can reduce the effect made by the sudden change of the ambient temperature. Such design, however, does not consider the fact that the signal processing means 34 is also affected by the change of the ambient temperature.

Also, another conventional radiation thermometer is disclosed in the U.S. Pat. No. 5,127,742. The radiation thermometer utilizes a shutter that is controlled to keep a constant temperature so that the ambient temperature will not affect the radiation thermometer upon temperature taking. However, the shutter must be heated continuously and controlled in an isothermal state. Consequently, the electricity consumption is large and the cost of using such thermometer increases. On the other hand, it is not easy to downsize this thermometer. Moreover, it is not suitable for commerce that the shutter takes a long time to reach a constant temperature. Therefore, it is a critical problem to be solved at present that how to provide an ear thermometer capable of measuring temperatures precisely and promptly without increasing the cost even when the ambient temperature is lower.

### SUMMARY OF THE INVENTION

In view of the above-mentioned problem, an object of the present invention is to provide an ear thermometer with an improved temperature coefficient and a method of calibrating the ear thermometer so that the target temperature measured at different ambient temperatures can be correctly compensated thereby enhancing the accuracy of the temperature measurement of the ear thermometer.

Another object of the present invention is to provide an ear thermometer with an improved temperature coefficient and a method of calibrating the ear thermometer so as to enhance the accuracy of the ear thermometer without increasing any additional cost and procedures of manufacturing calibration.

In order to achieve the above-mentioned objects, the ear thermometer with an improved temperature coefficient according to the present invention includes infrared radiation sensor means for sensing the infrared radiation coming from the target and generating a first electronic signal, temperature sensor means for sensing the temperature of the infrared radiation sensor means so as to use the temperature as an ambient temperature, analog/digital signal converting means connected to the infrared radiation sensor means and to the temperature sensor means for converting the first electronic signal and the second electronic signal into digital signals, information storing means for storing the calibrated information such as a temperature coefficient needed for calculating the temperature of the target, and signal processing means for calculating the temperature of the target according to the information.

The steps of manufacturing calibration for the ear thermometer according to the present invention include calibrating the temperature sensor means and calibrating the value of constant Kₜ. When the temperature sensor means is calibrated at two different calibration ambient temperatures, the temperature coefficient is simultaneously calculated for the use of compensation of the measured target temperature. The method of the temperature compensation is that, during the calibration of the constant Kₜ, the value of Kₜ is obtained at a constant calibration ambient temperature. If the ambient temperature of the measured target temperature is different from the temperature at the time of calibration, the temperature coefficient having already been obtained is used to compensate the value of Kₜ and then the value of Kₜ after the compensation is used to calculate the target temperature.

According to the present invention, a temperature coefficient is used for compensation since the value of Kₜ is a function of the ambient temperature. Therefore, even though the ambient temperature upon temperature taking is deviated far from the constant calibration ambient temperature, an accurate temperature can still be obtained. Also, in the invention, the temperature coefficient is obtained at the same time when the temperature sensor means is calibrated. Therefore, it is not necessary to execute a multiple sets of temperature calibration to obtain a more accurate temperature, as compared with the U.S. Pat. No. 4,797,840. Hence, the time required for the manufacturing calibration will not be increased.

### BRIEF DESCRIPTION OF THE DRAWINGS

FIG. 1 is a block diagram showing a calibration circuit of a conventional radiation thermometer.

FIG. 2 is a schematic diagram showing the applied electrical calibration signal and the responsive electrical signal generated by the pyroelectric sensor means when a calibration is performed by the calibration circuit of FIG. 1.

FIG. 3 is an architecture diagram showing the components of another conventional infrared radiation thermometer.

FIG. 4 is an architecture diagram showing the detailed configuration of the infrared radiation sensor means of FIG. 3.

FIG. 5 is a block schematic diagram showing an ear thermometer with an improved temperature coefficient of an embodiment according to the present invention.

FIG. 6 is flow chart showing a procedure of determining the temperature coefficient for the ear thermometer with an improved temperature coefficient of an embodiment according to the present invention.

FIG. 7 is a flow chart showing another procedure of determining the temperature coefficient for the ear thermometer with an improved temperature coefficient of an embodiment according to the present invention.

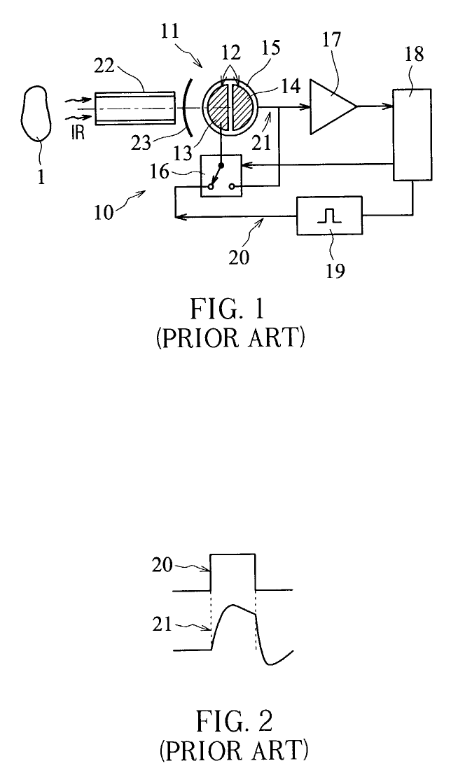

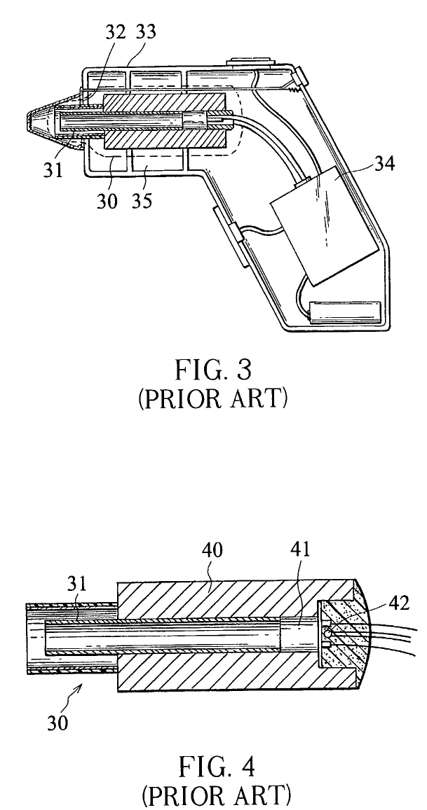

### DESCRIPTION OF THE PREFERRED EMBODIMENTS

An ear thermometer with an improved temperature coefficient and a method of calibrating the ear thermometer of an embodiment according to the present invention will be described below with reference to the drawings, wherein the same components will be denoted by the same reference numerals.

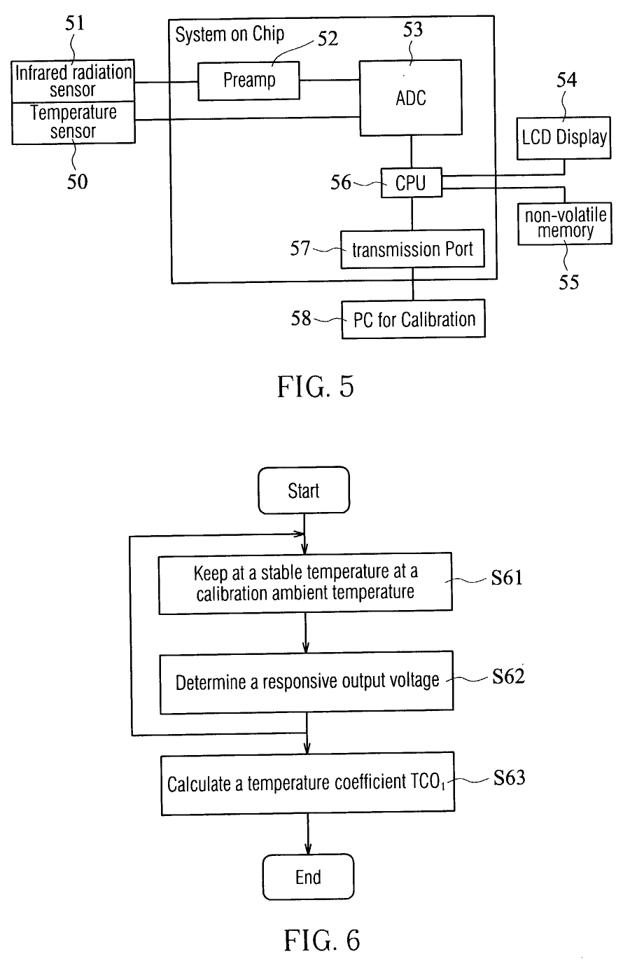

Referring to FIG. 5, an ear thermometer with an improved temperature coefficient according to the embodiment of the present invention includes infrared radiation sensor means 51, temperature sensor means 50, signal amplifying means 52, analog/digital signal converting means 53, information storing means 55, signal processing means 56, and display means 54. The infrared radiation sensor means 51 receives infrared radiation from the target and generates a first electronic signal. The temperature sensor means 50 measures the temperature of the infrared radiation sensor means 51, which is representative of an ambient temperature, and generates a second electronic signal. The first electronic signal is amplified by the signal amplifying means 52 and then is converted into a digital signal by the analog/digital signal converting means 53. The second electronic signal is directly coupled to the analog/digital signal converting means 53 for converting into a digital signal. The information storing means 55 stores the information needed for executing compensation due to the change of the ambient temperature, such as a temperature coefficient. The signal processing means 56 calculates the temperature of the target according to the first electronic signal, the second electronic signal, and the temperature coefficient. In the embodiment, the signal processing means 56 is a central processing unit (CPU). In addition, the ear thermometer can be connected to the computer 58 through transmission port 57 to execute calibration.

Next, two methods of determining the temperature coefficient according to the present invention will be described. It should be noted that the conventional method of calibrating the ear thermometer includes two steps. The first step is calibrating the temperature sensor means 50 and the second step is substituting a given target temperature, an ambient temperature, and an output of the infrared radiation sensor means 51 in the equation (B) to obtain the value of Kₜ.

Referring to FIG. 6, a first method of determining the temperature coefficient during the calibration of the temperature sensor means 50 is described as follows. First, an ear thermometer without a housing and a thermal shielding (not shown) is kept at a stable temperature in thermal equilibrium at a first calibration ambient temperature T_{amb1} (S61) and a responsive output voltage V_{ref1} thereof is determined (S62). By repeating the steps S61 and S62 once more, the ear thermometer is kept at a stable temperature in thermal equilibrium at a second calibration ambient temperature T_{amb2} and a responsive output voltage V_{ref2} thereof is determined. After that, a temperature coefficient TCO₁ is obtained by applying the following equation (E) (S63):

TCO₁=(V_{ref1}−V_{ref2})V_{ref1}/(T_{amb1}−T_{amb2}) (E)

In the embodiment, the first calibration ambient temperature T_{amb1} is 30° C. while the second calibration ambient temperature T_{amb2} is 15° C.

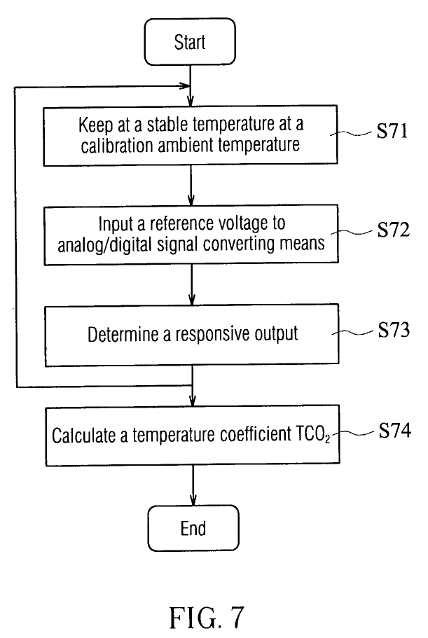

Referring to FIG. 7, a second method of determining the temperature coefficient during the calibration of the temperature sensor means 50 is described as follows. First, the ear thermometer without a housing and a thermal shielding is kept at a stable temperature in thermal equilibrium at the first calibration ambient temperature T_{amb1} (S71). Thereafter, a stable and precise reference voltage is input to the analog/digital signal converting means 53 (S72) and a responsive output Q_{dn1} thereof is determined (S73). By repeating the steps S71 to S73, a responsive output Q_{dn2} of the analog/digital signal converting means 53 is determined at the second calibration ambient temperature T_{amb2}. After that, a temperature coefficient TCO₂ is obtained by applying the following equation (F) (S74):

TCO₂=(Q_{dn1}−Q_{dn2})/Q_{dn1}/(T_{amb1}−T_{amb2}) (F)

As mentioned above, the present invention is applicable to each of the two methods of determining the temperature coefficient. Hereinafter a general reference TCO is used to represent both the temperature coefficient TCO₁ determined from the first method and the temperature coefficient TCO₂ determined from the second method.

After the temperature coefficient TCO is determined, it is stored in the information storing means 55. In the embodiment, the information storing means 55 is an electrically non-volatile memory. The temperature coefficient TCO is retrieved for the purpose of compensating the target temperature upon temperature taking.

After the step of calibrating the temperature sensor means 50, the ear thermometer is further calibrated to obtain the value of Kₜ. The ear thermometer provided with a housing and a thermal shielding at this time determines the output value Q_{dn0} of the analog/digital signal converting means 53 at a given target temperature Tₑₐᵣ₀ and a given constant calibration ambient temperature T_{ambBase}. The calibrated constant Kₜ₀ can be calculated by applying the equation (G), which is evolved from the equation (B):

Kₜ₀=(Tₑₐᵣ⁴−T_{ambBase}⁴)/Q_{dn} (G)

where Tₑₐᵣ is the target temperature, which is substituted by the given target temperature Tₑₐᵣ₀, and Q_{dn} is the electronic signal generated by the responsive means, which is substituted by the output Q_{dn0} of the analog/digital signal converting means 53.

In the embodiment, the given target temperature Tₑₐᵣ₀ is 38° C., and the given constant calibration ambient temperature T_{ambBase} is 25° C.

Because Kₜ in the equation (B) is a function of the ambient temperature, the deviation of Kₜ caused by the change of the ambient temperature can be compensated by applying the following equation (H) after the temperature coefficient TCO is obtained:

Kₜ=Kₜ₀(1+TCO(T_{amb}−T_{ambBase})) (H)

And when the value of Kₜ is substituted in the equation (B), the following equation (I) can be obtained:

Tₑₐᵣ=(Q_{dn}×Kₜ₀(1+TCO×(T_{amb}−T_{ambBase}))+T_{amb}⁴)^{(1/4)} (I)

After the manufacturing calibration is completed, the procedures of temperature measurement of the ear thermometer are:

1. Measure the ambient temperature T_{amb}.

2. The infrared radiation sensor means 51 receives infrared radiation from the target and generates a responsive output Q_{dn3}.

3. The signal processing means 56 compensates the value of Kₜ by using the temperature coefficient TCO that is stored in the information storing means 55 and calculates the target temperature Tₑₐᵣ by applying the equation (I).

The specific embodiment above is only intended to illustrate the invention; it does not, however, to limit the invention to the specific embodiment. Accordingly, various modifications and changes may be made without departing from the spirit and scope of the invention as described in the appended claims.

What is claimed is:

1. An ear thermometer with an improved temperature coefficient comprising:
infrared radiation sensor means for sensing an infrared radiation from a target and generating a first electronic signal;
temperature sensor means for sensing a temperature of the infrared radiation sensor means so as to use the temperature as an ambient temperature and generating a second electronic signal;
analog/digital signal converting means connected to the infrared radiation sensor means and the temperature sensor means for converting the first electronic signal and the second electronic signal into digital signals, respectively;
information storing means for storing a temperature coefficient; and
signal processing means for processing the first electronic signal generated by the infrared radiation sensor means and the second electronic signal generated by the temperature sensor means and compensating by using the temperature coefficient stored in the information storing means so as to calculate an amount of the infrared radiation from the target, and to obtain a target temperature according to the amount of the infrared radiation.

2. The ear thermometer as claimed in claim 1, further comprising:
signal amplifying means coupled between the infrared radiation sensor means and the analog/digital signal converting means for amplifying the first electronic signal generated by the infrared radiation sensor means and then entering into the analog/digital signal converting means.

3. The ear thermometer as claimed in claim 1, further comprising:
display means coupled to the signal processing means for displaying the target temperature calculated by the signal processing means.

4. The ear thermometer as claimed in claim 1, wherein the information storing means is an electrically non-volatile memory.

5. The ear thermometer as claimed in claim 1, wherein the signal processing means is a central processing unit.

6. The ear thermometer as claimed in claim 1, wherein the target temperature is calculated by the following equation:
Tₑₐᵣ=(Q_{dn}×Kₜ₀(1+TCO×(T_{amb}−T_{ambBase}))+T_{amb}⁴)^{(1/4)}
where Tₑₐᵣ is the target temperature, Q_{dn} is an output of the infrared radiation received by the infrared radiation sensor means, T_{amb} is the ambient temperature, T_{ambBase} is a constant calibration ambient temperature of the ear thermometer when a manufacturing calibration is executed, Kₜ₀ is a constant calculated from the constant calibration ambient temperature, and TCO is the temperature coefficient stored in the information storing means.

7. A method of calibrating the ear thermometer with an improved temperature coefficient comprising:
determining output voltages of temperature sensor means at a first calibration ambient temperature and a second calibration ambient temperature, respectively, thereby calibrating the temperature sensor means for enhancing accuracy thereof and calculating a temperature coefficient at the same time, and
determining a responsive output of the temperature sensor means at a given target temperature and a given constant calibration ambient temperature thereby calculating a calibration constant according to the responsive output.

8. The method as claimed in claim 7, wherein the temperature coefficient is calculated by the following equation:
TCO=(V_{ref1}−V_{ref2})/V_{ref1}/(T_{amb1}−T_{amb2})
where TCO is the temperature coefficient, T_{amb1} is the first calibration ambient temperature, T_{amb2} is the second calibration ambient temperature, and V_{ref1} and V_{ref2} are the output voltages determined from the first calibration ambient temperature and the second calibration ambient temperature, respectively.

9. The method as claimed in claim 7, wherein the calibration constant is calculated by the following equation:
Kₜ₀=(Tₑₐᵣ⁴−T_{ambBase}⁴)/Q_{dn}
where Kₜ₀ the calibration constant, Tₑₐᵣ is the given target temperature, T_{ambBase} is the given constant calibration ambient temperature, and Q_{dn} is the responsive output.

10. The method as claimed in claim 7, wherein the first calibration ambient temperature is 15° C.

11. The method as claimed in claim 7, wherein the second calibration ambient temperature is 30° C.

12. The method as claimed in claim 7, wherein the given target temperature is 38° C.

13. The method as claimed in claim 7, wherein the given constant calibration ambient temperature is 25° C.

14. A method of calibrating the ear thermometer with an improved temperature coefficient comprising:
inputting a stable and precise reference voltage to analog/digital converting means of the ear thermometer and determining outputs thereof at a given first calibration ambient temperature and a given second calibration ambient temperature, respectively, thereby calibrating temperature sensor means and calculating a temperature coefficient, and
determining a responsive output of the temperature sensor means at a given target temperature and a given constant calibration ambient temperature thereby calculating a calibration constant according to the responsive output.

15. The method as claimed in claim 14, wherein the temperature coefficient is calculated by applying the following equation:
TCO=(Q_{dn1}−Q_{dn2})/Q_{dn1}/(T_{amb1}−T_{amb2})
where TCO is the temperature coefficient, T_{amb1} is the first calibration ambient temperature, T_{amb2} is the second calibration ambient temperature, and Q_{dn1} and Q_{dn2} are the output determined from the first calibration ambient temperature and the second calibration ambient temperature, respectively.

16. The method as claimed in claim 14, wherein the calibration constant is calculated by applying the following equations:
Kₜ₀=(Tₑₐᵣ⁴−T_{ambBase}⁴)/Q_{dn}
where Kₜ₀ is the calibration constant, Tₑₐᵣ is the given target temperature, T_{ambBase} is the given constant calibration ambient temperature, and Q_{dn} is the responsive output.

17. The method as claimed in claim 14, wherein the first calibration ambient temperature is 15° C.

18. The method as claimed in claim 14, wherein the secondcalibration ambient temperature is 30° C.

19. The method as claimed in claim 14, wherein the given target temperature is 38° C.

20. The method as claimed in claim 14, wherein the given constant calibration ambient temperature is 25° C.
